(19) United States
(12) Patent Application Publication
(10) Pub. No.: US 2002/0143777 A1
(43) Pub. Date: Oct. 3, 2002

(54) Method and apparatus for a new interactive system which improves prospect identification and facilitates dollar specific gift targeting

(76) Inventor: Charles Whelan, New York, NY (US)

Correspondence Address: Thomas A. O'Rourke, Wyatt, Gerber & O'Rourke, 99 Park Avenue, New York, NY, 10016, US

(21) Appl. No.: 09/748,790

(22) Filed: Dec. 26, 2000

(51) Int. Cl. G06F 7/00

(52) U.S. Cl. 707/100

(57) ABSTRACT

An apparatus, system and method for facilitating and improving prospect identification and facilitating dollar specific gift targeting is described. The invention includes a central data processor for storing, indexing and manipulating data and a memory means for storing and selectively retrieving specific portions of a database specified by a user request There is a communication link to establish a communication path between the central data processor and one or more external databases in response to a user request. A prospect data processor selectively generates prospect data, and an analysis storage, retrieval and means are also included for storing and retrieving selected prospect data and for returning generated codes to a client database.

### FIELD OF THE INVENTION

The present invention relates to an interactive computerized electronic system which uses customized criteria to identify potential donors and to evaluate and catalogue the specific dollar potential and projected yield of existing and potential donors and others. The present invention has particular applicability in the field of gift targeting for charitable institutions. In particular, the present invention relates to a method and apparatus for generating data specific to each individual analyzed in order to improve prospect identification and facilitate dollar specific gift targeting for existing and potential donors, and in which such individual-specific data is selectively generated and analyzed for purposes of creating codes to be made available to the client. This data may be appended to each existing and prospective donor's record on the client's database, by making the data available by electronic means or otherwise. Although the present invention has particular application in the field of charitable giving the teachings of the present invention may also be used to identify prospective purchasers for a number of goods and services particularly high end goods and services.

### BACKGROUND OF THE INVENTION

Institutions, including non-profit organizations, today rely on funding from an array of sources to support their mission. Traditionally these sources are government funding, charitable foundations, corporate foundations and individuals. Increasingly, organizations are relying on gifts from individuals to sustain the organization.

In the past, donors were persons or other charitable institutions that were contacted personally by the fund-raisers of the institution seeking funds. One shortcoming of such a method of raising funds is the cost of reaching the donors. Personal contacts are time consuming and as a result labor intensive thus adding to the cost per dollar of contributions received. Another shortcoming of this approach is its inability to effectively identify and prioritize prospective donors. Resultantly, potentially good donors are overlooked and are therefore not cultivated or solicited effectively.

Today, due to the busy schedules, working long hours and other commitments, it is particularly impracticable to reach a wide donor pool through personal solicitations. Institutions have therefore resorted to mass mailing of promotional literature and solicit funds from the recipients of such literature. Often organizations in search of donore send this material to a general audience which may or may not include existing donors. This broadcast distribution of solicitation materials to a general audience typically results in small gifts with many prospects choosing not to respond. Such futility may arise due to several reasons, some of them are: the target donors being asked for a gift substantially lower than his or her means, or being unable to afford a contribution, or having a low affinity for the cause and/or institution.

As organizations become more sophisticated - employing more skilled fund raising professionals and state of the art fund raising software - there has been an increasing demand for a method and system that effectively segments or targets their individual constituencies. An objective is to use the principles of commercially proven target marketing when making decisions about how best to manage individuals with the greatest capacity and inclination to give. The questions non profit organizations are repeatedly asking include:

How do I find my very best prospects (prospective identification);

What should I ask each of my constituents to give (gift targeting);

Will the techniques I use lower the cost to raise a dollar?

### SUMMARY OF INVENTION

The present invention relates to an interactive method and apparatus for improving prospect identification and facilitating dollar specific gift targeting. Applicant's interactive system may include one or more of the following, it identifies an organizations wealthiest donors and prospective donors and provides evaluation regarding their inclination to give; it can target the dollar specific gift potential of every individual on an organization's database; it provides a dollar specific assessment of every individual's gift potential, typically for a three to five year period; it makes recommendations on prospect research priorities; it returns this information to the organization by any suitable means including electronically and it may be installed on the organizations database of individuals or made accessible to them via electronic means.

Applicant's interactive system may includes a central data processor for storing, indexing and manipulating data, memory means for storing and selectively retrieving portions of a database specified by a user request, a communication means or communications path between a central data processor and the client's database as well a external databases, a prospect data processor for selectively generating profile data on a prospect, an analysis storage and retrieval means for storing and retrieving selected prospect data and a communication means for returning this information to the organizations database on individuals.

It is an object of the present invention to provide an apparatus and method for evaluating and prioritizing existing and potential donees.

It is another object of the present invention to provide a method and apparatus for identifying and selecting, from cataloguing provided client data and external databases, donors for solicitation of funds or other donations, and targeting such selected donors.

It is yet another object of the present invention to provide a method and apparatus for generating a database of selective prospective and existing donors with the highest gift potential for use for use by the organization.

It is yet another object of the present invention to provide a method and apparatus for prioritizing prospective and existing donors with the highest gift potential based on an individuals affinity for the organization.

It is yet another object of the present invention to provide an apparatus and method for quantifying the dollar specific gift potential of individuals on a client's database including both donors and prospects, in order to increase a clients fund raising.

It is yet another object of the present invention to provide an apparatus and method for identifying the appropriate method of solicitation.

It is yet another object of the present invention to provide an apparatus and method for returning information obtained using the method and system to the client in an electronic format that can be installed on the client's database or linked to the database, including in such a way where this information is accessible to each individual's constituent file on the client database.

These and other objects and advantages of applicants' method and apparatus for the generation and efficient and advantageous use of a donor database can best be understood by reference to the following detailed description in conjunction with the accompanying drawings.

### BRIEF DESCRIPTION OF THE DRAWINGS

FIG. 1 is a schematic block diagram of a system utilizable for the generation and use of a donor database in accordance with the present invention.

FIG. 2 is a schematic logic block diagram of a system for the generation of an optimized donor database wherein the donee institution provides a database of existing donees.

FIG. 3 is an example of the screen version of a table that may be generated from the data.

### DETAILED DESCRIPTION OF PREFERRED EMBODIMENTS

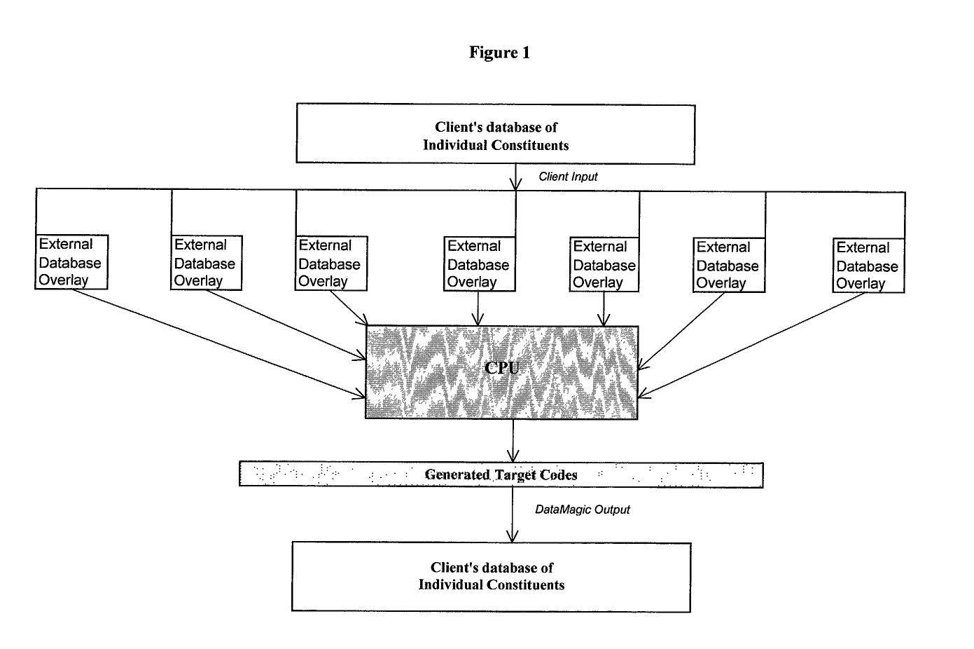

Referring to FIG. 1, there is shown a block diagram of a system that can be utilized for the generation and use of a donor database in accordance with one embodiment of the present invention. As shown, the client provides a database containing data of entities collected by the client and may include individuals with an affinity to the client. Such entities may be persons who have made past contributions, individuals with general interest in the organizations mission, persons who have made purchases at an affiliated store, etc. Such a database can be expressed in electronic media. The data from the database is imported into the CPU, which may, for example, comprise a central data processor with an associated system memory and standard peripherals. The CPU also has selectively addressable memory capable of storing digital data. The CPU may also be a network of computers linked together in a wide area network (WAN) or a local area network (LAN), combinations thereof, or one or more independent workstations.

At the CPU, the data provided by the donee-client is read and the donor information is tracked using a unique identification number which has been assigned by the client to each record. The identification number includes, but is not limited to an alphanumeric code that serves as a means for identifying a particular record. Such assignation of codes may be necessitated, amongst other reasons, for the purpose of distinguishing between persons who have the same name or other similarities in their record of information. The identification number may be randomly generated or may have a significance, for example, may have the year in which the donor first gave a gift as a prefix. A mere reading of the identification number would therefore provide some information as to the record or data profile to which it is linked.

The client's database of records that is provided by the donee-client may consist of data such as, name, address, telephone number, gift history, and other biographical data. Against each record, the CPU selectively accesses data from one or more external databases that provides current, usually publically available information about each entity to which the record pertains. The information that the external database would provide access to includes, but is not limited to, high net worth indicators, SEC insider trading information, success in various business ventures, recent promotions, change of job, change in members of the family, change in financial status, change of residence, date of birth, etc. The external database may be maintained within the CPU. It could also be an in-house database compiled as a result of research and data-mining.

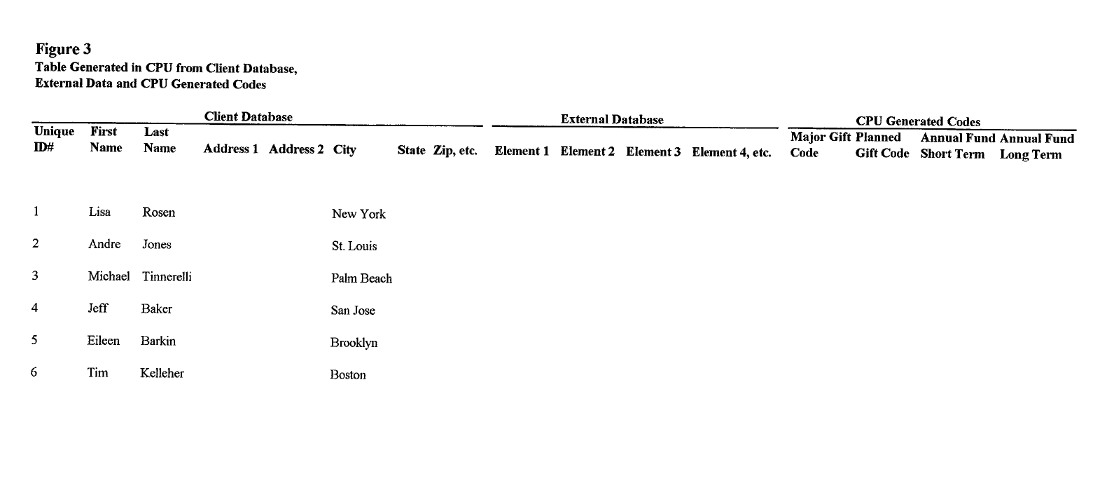

An external database is now queried by the CPU. Such queries would typically be by each individual's unique identification number. In response to this query, an external database is searched and this provides updated data or file enhancements for each donor-entity. The updated data, amongst other data, gives the most current financial status, nature of job held, change of residence, etc. This data profile is imported into the CPU where it is linked via each individual's unique identification number to the biographical data received from the client. The data in these fields can then be, preferably, expressed in a tabular form. By “tabular form” it is meant that the data contained in the fields is arranged in accordance with desired criterion. It may include a traditional table or another arrangement of fields and the data contained therein. An example of the screen version of one such table that may be generated is depicted in FIG. 3.

This process is repeated for each record and the entire data compiled, preferably, in such tabular form. In response to queries that arrange, divide, and group the data contained in the fields, the updated and revised data of the donor entities are divided into groups in accordance with certain criteria. For example, the donor data profiles may be arranged in accordance with the gift-giving capacity, or arranged by affinity for the organization, or both, etc. These tabular arrangements are formatted and placed in a form suitable for use by the client. This arrangement forms the output, which contains target codes assigned to each record provided by the client. The geodemographic and wealth information (databases)as well as entity's biographical and gift giving history (supplied by client), if any, provide the basis for assignment of the dollar specific gift-giving potential and yield of each entity. This data can now be used by the client to target specific individuals for specific ask amounts or target specific groups of individuals for specific dollar ask amounts—leading directly tom the generation of funds. For example, the entities targeted for a gift of $50,000 or more who are most closely linked to the client may be targeted in a particular manner and then pursued on a high priority basis.

In an alternative embodiment, the client may not provide a client database. In this embodiment CPU 4, in accordance with the present invention, will search external databases for potential donors in response to appropriate queries. An example of such a query could be a search for all persons who have registered luxury cars during the previous year. The persons thus identified would form prospective donors with a relatively higher gift-giving potential. Furthermore, such persons may be requested to give a gift of a higher amount than would have been requested in the past in view if this information. Several such queries will generate lists of persons who are in varying degrees of financial well-being. The data profiles thus mined will be categorized and formatted in a manner as outlined above. This formatted and categorized data, each profile having a gift-giving potential (both generally as well as in actual money amount), will enable the client to approach the person accordingly.

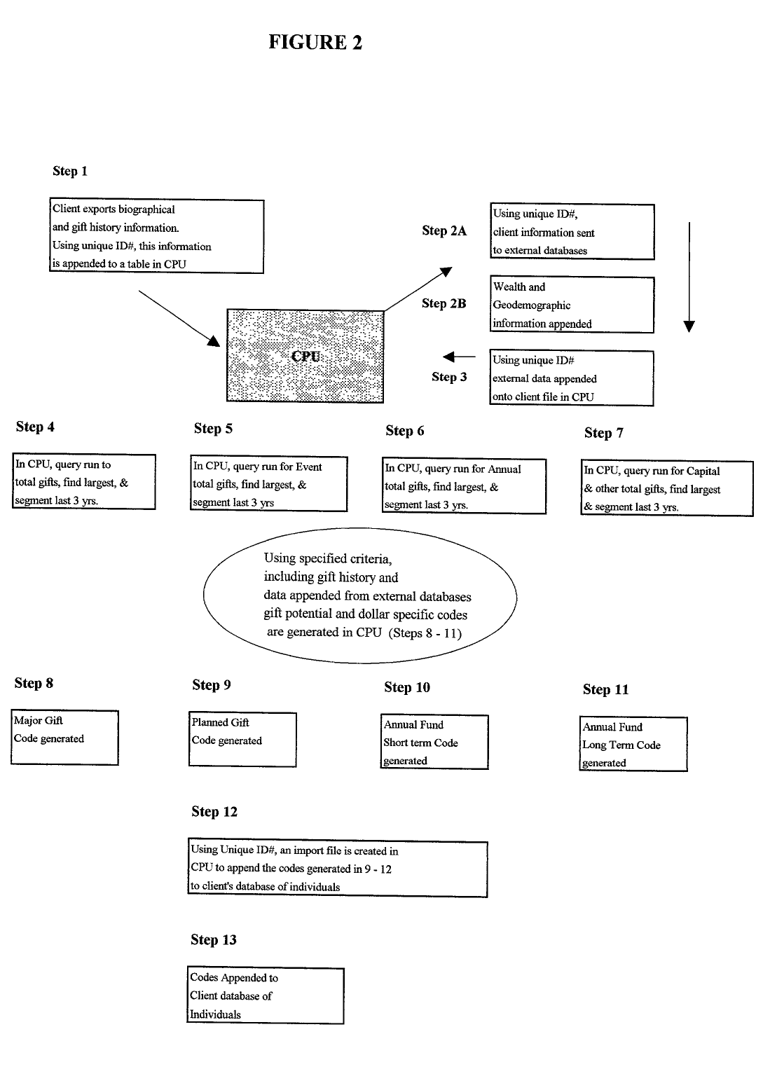

Referring now to FIG. 2, there is shown a logic block diagram of a system that can be utilized in accordance with the present invention. In Step 1, the data provided by the client which may include biographical data and gift history is exported from client's database to the CPU. Steps 2a abd 2b demonstrate that by using each entity's unique identification number, the data supplied by the client is supplied by the client is sent to one or more external databases, which are mined for publically available geo-demographic and wealth indication information for each entity. Step 3 links he selectively accessed data appended to each entity's record to the client information by using each entity's unique identification number.

A series of steps 4, 5, 6, and 7, sum the value of all the gifts given, the total number of gifts given, and the amount of the largest gift, and segments these gifts into categories for each individual. Step 4 is a summation step and it provides the total amount of the value of all gifts given by a donor, the total number of gifts given by that donor and the value of the largest gift given by that individual, the last three year total given by that donor (in accordance with the invention, the number of years for which gifts are totaled may be a variable), the total for each of the last three years given by that donor and the largest gift given by that donor in the last three years. Step 5 provides similar data per donor except the gifts are limited to those given for special occasions. An example of a special event could be a golf outing held to raise funds for the construction of a library. Step 6 provides similar data per individual to step 4 except it is limited to gifts given towards the client's annual fund raising program. Step 7 provides similar data to step 14 but is limited to the gifts given towards capital fund raising as well as other gifts not given for a special event or to an annual fund raising program.

A series of queries then analyze these data profiles and separate individuals into categories based on the gift-giving potential of each individual. The purpose of performing this step is to screen and sort the data for individuals who demonstrate varying degrees of potential for making gifts. Furthermore, these individuals are grouped according to the amount of gift that can be requested from them. These categories are arrived at using judiciously pre-selected values for variables and operators and comparators. For example the first category could consist of persons who have a median household income ≧$75,000 OR an estimated household income 7 AND wealth rating ≧8 AND P$ycle code=1, total gifts ≧$2,000 OR wealthengine codes ≧1AE OR 1BE OR 2AE OR 2CE OR 2DE OR 5AE OR 5BE OR 5CE. This would constitute the top pool of prospective donors. The pool may be modified by modifying the criteria. This process is repeated for other categories of potential donors.

Step 8 shows that individuals are selected, using predetermined gift history and external data criteria, for their ability to give a major gift of $50,000 or more to the client. For example, the major gift category could consist of persons who have a median household income of $75,000 or an estimated household income of 7 and a wealth rating >8. Once selected, individuals in this category are further sub-divided within this category according to their affinity for the: client. For example, an individual could be given a major gift code with high affinity. because this individual has given a gift of $100,000 to the client in the last three years.

Step 9 shows that individuals are selected using predetermined gift history and external data criteria for their ability to give a planned or estate gift of $50,000 or more to the client. For example the planned gift category could consist of persons who have a median household income of $75,000 or more and are aged 55 years or older. Once selected, individuals in this category are further sub-divided within this category according to their affinity for the client. For example, an individual could be given a planned gift code with a moderate affinity because they had previously served on the client's Board of Directors. Individuals in this group may or may not have been selected for the major gift category.

Step 10 shows that each individual provided to applicant by the client is assigned an annual fund short term code, based on predetermined gift history and external data criteria. Each individual will be assigned a dollar specific amount (from $25-$10,000 or more) that they can be asked to give to the client on an annual basis. This amount assigned to each individual from the client database—reflects an individual's ability to give and at the same time takes into account a gift which an individual is most likely to give to the client. The annual fund short term code is an amount that can be requested on the individual in the first 6 months of the completion of this process.

Step 11 shows that each individual provided to applicant by the client is assigned an annual fund long term code, based on predetermined gift history and external data criteria. Each individual will be assigned a dollar specific amount (from $25-$10,000 or more) that they can be asked to give to the client on an annual basis. This amount—assigned to each individual from the client database—reflects an individual's ability to give and at the same time takes into account a gift which an individual is most likely to give to the client. The annual fund long term code is an individual's true gift potential—an amount that can be requested within a three to five year period. It will be appreciated by those skilled in the art that depending on the institution and/or the type of donors or potential donors etc. one or more of these steps may be eliminated.

Once individuals have been assigned to the categories, the data which contains the assignments is rendered into a client usable format. This file is returned to the client. The client installs this information back onto their database or gains access to this information via electronic means, using the unique identification number for each individual to link the new data to the individual's existing record. The client now has information for each individual on their database which categorizes existing and prospective donors according to their major and planned gift potential and affinity. The client database also now contains short term and long term specific dollar ask amounts reflecting each entity's ability and willingness to give to the client on an annual basis. With the information generated by the applicant, the client's fund raising efforts can now be directed towards the donors and prospective donors, incorporating the results obtained by the use of this invention, thereby increasing the amount of gifts received as well as maximizing the giving potential of each donor.

In an alternate embodiment, there may be summations of all gifts, gifts for annual funds, gifts for special events, and gifts for capital funds and other gifts not given to the annual fund or special events, for the past three years per individual. These gifts are also totaled for each of these past three years. In accordance with the present invention, the number of years for which the gifts are totaled may be a variable. Alternatively, the next series of steps can consist of cross tabbing these summations and selections by campaign and year. Cross tabbing consists of linking together two or more fields, in accordance with predetermined criterion. For example, two fields may be cross tabbed, i.e. linked together using the operator “greater than”. In the preferred embodiment, the results of the summations are cross tabbed i.e. placed in one row per individual, and subsequently separated by campaign and then by year. Separate tables may be made for total gifts, total events, total annual fund, total capital and other gifts, events, and gifts. In one embodiment, these tables may be constructed using a spreadsheet program such as ACCESS or any other such similar program that permits manipulation of data in tabular form.

Using this data, other databases are mined for an updated profile of geodemographic data per individual or entity. External databases may be maintained in-house or may be other publicly available databases, such as, credit rating, balance sheets of publicly held corporations, etc., which are connected to the CPU. This selectively accessed data is then linked to each identification number on the CPU. As an example, given below is a detailed description of steps that may be performed as have been outlined above:

Once the database file is obtained from the client, two queries are made in order to export the information required. The first is a query to export the biographical information and the second will export the necessary gift information. Two such default queries for this process are listed below. Adjustments specific to each client may be necessary.

### Query 1 (Biographical Information)

Open RE Query

Select the “Create New Query” icon or File, New

The Add New Query Screen will appear

Select Query Type: “Individual” and Query Format “dynamic”

From the Biographical tab, pull the following fields into the output box:

Constituent ID

Last Name

First Name

Middle Name

Title 1, Title 2

Suffix 1, Suffix 2

Address Lines (Primary)

City, State, Zip (Primary)

Address Type (Primary)

Business Organization Name

Business Position

Constituency Code Description

*In Constituent Management, make sure Primary Address=Home Address before exporting this query.

Save Query (i.e., “DMBio”)

Open RE Export

Select the “Create a New Export” icon

Select Export type “Constituent” and Records to Include “Selected Records”

A From Group box will appear. Select the Biographical Query just created in RE Query by clicking on the arrow on the right hand side of this box and scrolling through the list of queries OK

Return to the New Export Screen and check box Load Query Output Fields (this tells RE Export to select the same fields that were selected in the Biographical Query) OK

Address Criteria screens will appear for each address line (including City, State and Zip)

Select “Based on criteria” for each line

Click the Export Icon (the suitcase)

An Export Format Screen will appear

Select “Comma Separated Value” OK

A Constituency Parameters Screen will appear

Select the number of constituencies you would like to have appear in the export (i.e., 1)

Under Constituency Criteria, choose “Selected Constituencies”

Select all constituencies pertaining to an individual (this will vary with each client) For example: “INDIV” “Board”, etc.)

An Enter Export File Name Screen will appear

Name the Export (i.e., DMBio) & choose the Drive and Folder you would like the export to be sent to (i.e., g:/wrk/“client name”/PID/ “DMBio”) OK

A Processing Export File screen will appear

Once the file is 100% exported, a control report appears.

The File has now been exported to the location you have selected.

### Query 2 (Gift History)

From the Biographical Tab, pull the following field into the Output Box:

Constituent ID

From the Gift Tab, pull the following fields into the Output Box:

Gift Amount

Gift Date

Gift Campaign Description

Gift Fund Description

Gift Appeal Description

Pull the “Gift Type” Field into the Filter Box to select specific information from this field:

Gift Type Select “One of” and choose everything except Pledge and MG Pledge

Export this query directly from RE Query into the Drive and Folder in which the database is set up for the PID.

A Field can be filtered and not included in the Output Box (i.e., gift type)

### Creating a Database to Import Queries

Once the information has been exported, a database must be created to import the information. A spreadsheet program such as ACCESS may be used for this purpose.

Open ACCESS

File, New Database. Save in client folder (e.g., g/wrk/client name/PID/database.mdb)

Click File, “Get External Data”, Import

Choose Text Files (.csv) as File Type

Select RE Export file for Biographical Information saved in comma separated value (.csv) format (i.e., “DMBio.csv)

Click “IMPORT”

Access will convert file using the following prompts:

Choose file type that best describes your data

Select Delimited, “NEXT”

Select Delimiters and Text Qualifiers (i.e., Comma, “”), “NEXT”

Store Data in “New Table”

Field Options, “NEXT”

Select No Primary Field

Select Table Name, “FINISH”

Repeat process for Gift Export, importing into the same database.

When the two tables are in the ACCESS database, rename the fields.

For the Bio table, rename the fields based on what they were named in the RE program, making sure that the constituent ID field is renamed “ConsID” with a “text” data type”

For the gift table, rename the fields in the following way:

Field 1—Field Name: “ConsID”, data type “text”

Field 2—Field Name: “Gift Amount”, data type “currency”

Field 3—Field Name: “Date”, data type “Date/Time”

Field 4—Field Name: “Campaign”, data type “text”

Field 5—Field Name: “Fund”, data type “text”

Field 6—Field Name: “Appeal”, data type “text”

Once the tables are renamed, several queries must be created to sort the gift history for the prospect identification and gift targeting process.

### Query #1—Total Gifts

This Query will give you the sum, number of gifts and largest gift amounts for all gifts per individual

In Design View, Select the Gift Table

Pull each field down onto the Query Grid in the following order:

ConsID

Gift Amount

Gift Amount

Gift Amount

* Note: The Gift Amount field should be pulled down three times because the gift amount information will be sorted differently in each field.

On the Toolbar, select the Totals icon A Total Row will appear on the Query Grid

In the first Gift Amount Field, change “Group by” in the Total Row to “Max”

In the second Gift Amount Field, change “Group by” in the Total Row to “Count”

In the third Gift Amount Field, change “Group by” in the Total Row to “Sum”

Run Query

### Query # 2—“Total Events”

This Query will give you the sum, number of gifts and largest gift amounts for all special events gifts per individual.

Repeat the above instructions AND

Pull down the “Campaign” field onto the Query Grid

Type “Events” in the criteria row

Run Query

*Note the criteria may vary from client to client. You may need to use the Fund or Appeal Field to sort out the Special Events Gifts instead of the Campaign field. Also, there may be more than one category of events to be added to the criteria row. For example, the client may sort out event gifts in the Fund Field and have a different fund code for each event.

### Query # 3—“Total Annual Fund”

This Query will give you the sum, number of gifts and largest gift amounts for all annual fund gifts per individual

Repeat the instructions from Query #1 AND

Pull down the “Campaign” field onto the Query Grid Type “Annual Fund” in the criteria row

Run Query

*Note the same fluctuation by client will occur in this query as well. There may be a series of Annual Fund categories that must be added to the criteria for this query. These categories may be sorted in the Fund or Appeal field.

### Query # 4—“Total Capital or Other Gifts”

This query will give you the sum, number of gifts and largest gift amounts for all capital and other gifts not given to the annual fund or for a special event for each individual in the database.

Repeat the instructions from Query #1 AND

Pull down the “Campaign” field onto the Query Grid Type “Capital” in the criteria row

Run Query

*Note the same fluctuation by client will occur in this query as well. There will be a series of Capital gift categories and categories not falling under annual fund or special event giving that must be added to the criteria for this query. These categories may be sorted in the Fund or Appeal field.

### Query # 5—“Events”

This Query will give you the sum of gifts over the last three years as well as the total for these three years specifically for “Events”per individual.

Repeat the instructions from query #1 AND

Add “Date” to the Query

In the criteria row for “Date”, type: >=97. This will only run gifts only from 1997 and forward.

Add the Campaign Field to the Query Grid

In the Criteria Row for the Campaign Field, type “Events”

Run Query

*Note that again the criteria may be different for each client. The criteria for this query, however, must be identical to the criteria in the “Total Events” query.

### Query #6—“Annual Fund”

This Query will give you the sum of gifts over the last three years as well as the total for these three years specifically for Annual Fund per individual.

Repeat the instructions from Query # 5

Except, In the Criteria Row for the Campaign Field, type “Annual Fund”

Run Query

*Note that again the criteria may be different for each client. The criteria for this query, however, must be identical to the criteria in the “Total Annual Fund” query.

### Query # 7—“Capital and Other Gifts”

This Query will give you the sum of gifts over the last three years as well as the total for these three years for all capital and other gifts not given to the annual fund or for a special event for each individual in the database.

Repeat the instructions for Query # 5, But

In the Criteria Row for the Campaign Field, type “Capital”

Run Query

*Note that again the criteria may be different for each client. The criteria for this query, however, must be identical to the criteria in the “Total Capital and Other Gifts” query.

### Query #8—“Crosstab Total Events”

This query will place all gifts in the “Total Event” query in one row per individual and separate each gift by Campaign.

select the data from the “Total Events” query.

NEXT

Select the field values you want for row headings:

ConsID

NEXT

Select the field values you want as column headings

Campaign

Select the number you want calculated for each column and row intersection

Field: Sum of Gift Amount Function: Sum

FINISH

### Query # 9—“Crosstab Total Annual Fund”

This query will place all gifts in the “Total Annual Fund” query in one row per individual and separate each gift by Campaign.

Select the data from the “Total Annual Fund” query.

NEXT

Select the field values you want for row headings:

ConsID

NEXT

Select the field values you want as column headings

Campaign

Select the number you want calculated for each column and row intersection

Field: Sum of Gift Amount Function: Sum

FINISH

### Query # 10—“Crosstab Total Capital and Other”

This query will place all gifts in the “Total Capital and Other” query in one row per individual and separate each gift by Campaign.

Select the data from the “Total Capital and Other” query.

NEXT

Select the field values you want for row headings:

ConsID

NEXT

Select the field values you want as column headings

Campaign

Select the number you want calculated for each column and row intersection

Field: Sum of Gift Amount Function: Sum

FINISH

### Query #11—“Crosstab Events”

This query will place all gifts in the “Events” query in one row per individual and separate each gift by year.

Select the data from the “Events” query.

NEXT

Select the field values you want for row headings:

ConsID

NEXT

Select the field values you want as column headings

Date

Select the number you want calculated for each column and row intersection

Field: Sum of Gift Amount Function: Sum

FINISH

### Query #12—“Crosstab Annual Fund”

This query will place all gifts from the “Annual Fund” query in one row per individual and separate each gift by year.

Select the data from the “Annual Fund” query.

NEXT

Select the field values you want for row headings:

ConsID

NEXT

Select the field values you want as column headings

Date

Select the number you want calculated for each column and row intersection

Field: Sum of Gift Amount Function: Sum

FINISH

### Query # 13 “Crosstab—Capital and Other Gifts”

This query will place all gifts in the “Capital and Other” query in one row per individual and separate each gift by year.

Select the data from the “Capital and Other” query.

NEXT

Select the field values you want for row headings:

ConsID

NEXT

Select the field values you want as column headings

Date

Select the number you want calculated for each column and row intersection

Field: Sum of Gift Amount Function: Sum

FINISH

### Query #14 “Total Gifts Make-Table Query”

This query will use the Total Gift Query to make a table just for total gifts.

Copy “Total Gifts” Query

Rename new query (i.e., “Total Gifts to Table”) and run the Make-Table Query

Name new table “Total Gifts Table”

Run Query

Once the Total Table is created, rename the following fields:

Change field “Count of Gift Amount” to “Total Count”

Change field “Max of Gift Amount” to “Largest”

Change field “SumofGift Amount” to “Total”

### Query # 15 “Total Events Make-Table”

This query will use the Total Events Cross tab Query to make a table just for total events gifts.

Make a copy of the Total Events Cross tab query

Rename new query (i.e., “Total Events to Table”)

In design view, click on the Query Type icon and select “Make-Table Query”

Or on the toolbar select “Query” and select “Make-Table Query”

Make a new table. Table Name: “Total Events Table”

Run Query

The new table will appear.

Once the Total Event Table is created, rename the following fields:

Change field “Countof Gift Amount” to “Total Event Count”

Change field “Maxof Gift Amount” to “Largest Event”

Change field “SumofGift Amount” to “Total Event”

### Query # 16 “Total Annual Fund” Make Table Query

This query will use the Total Annual Fund Cross tab Query to make a table just for Capital and other gifts.

Repeat the Instructions for Query #15

Except, Make a copy of the “Total Annual Fund Query” and

Rename new query and run the Make-Table Query

Make Table “Total Annual Fund” and

Once the Total Annual Fund Table is created, rename the following fields:

Change field “Countof Gift Amount” to “Total Annual Fund Count”

Change field “Maxof Gift Amount” to “Largest Annual Fund”

Change field “SumofGift Amount” to “Total Annual Fund”

### Query # 17 “Total Capital and Other” Make Table Query

This query will use the Total Capital and Other Gift Cross tab Query to make a table just for Capital and other gifts.

Repeat the Instructions for Query #15

Except, Make a copy of the “Total Capital and Other Query” and

Rename new query and run the Make-Table Query

Make Table “Total Capital and Other” and

Once the Total Capital and Other Table is created, rename the following fields:

Change field “Countof Gift Amount” to “Total Annual Fund Count”

Change field “Maxof Gift Amount” to “Largest Annual Fund”

Change field “SumofGift Amount” to “Total Annual Fund”

### Query #18 “Events Make-Table”

This query will use the Events Cross tab Query to make a table just for events gifts.

Make a copy of the Events Cross tab query

Rename new query (i.e., “Events to Table”)

Make a new table. Table Name: “Events Table”

Run Query

The new table will appear.

Once the Events Table is created, rename the following fields:

Change field “97” to “Event 97”

Change field “98” to “Event 98”

Change field “99” to “Event 99”

Change field “Total of SumofGift Amount” to “Total Event 97-99”

### Query #19 “Annual Fund” Make Table Query

This query will use the Annual Fund Cross tab Query to make a table just for Capital and other gifts.

Repeat the instructions from Query #18

Except Make a copy of the “Annual Fund” Query and

Rename new query and run the Make-Table Query

Make Table “Annual Fund Table”

Once the Annual Fund Table is created, rename the following fields:

Change field “97” to “Annual Fund 97”

Change field “98” to “Annual Fund 98”

Change field “99” to “Annual Fund 99”

Change field “Total of SumofGift Amount” to “Total Annual Fund 97-99”

### Query #20 “Capital and Other Gifts Make-Table Query”

This query will use the Capital and Other Gift Cross tab Query to make a table just for Capital and other gifts.

Repeat the steps for Query #18 BUT

Make a copy of the “Capital and Other Gift Cross tab” Query

Rename new query and run the Make-Table Query

Name new table “Capital and Other Gift Table”

Once the Capital and Other Gift Table is created, rename the following fields:

Change field “97” to “Capital and Other 97”

Change field “98” to “Capital and Other 98”

Change field “99” to “Capital and Other 99”

Change field “Total of SumofGift Amount” to “Total Capital and Other 97-99”

### Import Instructions for Data Overlays

### High Net Worth & Geodemographic Overlay

Unzip High Net Worth and Geodemographic disks returned

Open ACCESS

Open the database just created for the RE import

Click File, “Get External Data”, Import

Choose Text Files (.csv) as File Type

Select High Net Worth file saved in comma separated value (.csv) format

Click “IMPORT”

Access will convert file using the following prompts:

Choose file type that best describes your data

Select Delimited

NEXT

Select Delimiters and Text Qualifiers

NEXT

Store Data in “New Table”

Field Options

NEXT

Select No Primary Field

Select Table Name

FINISH

Repeat for Geodemographic file saved in comma separated value format (.csv)

Once the High Net Worth and Geodemographic files are in ACCESS, rename the fields you will need for the PID:

### High Net Worth

These codes are usually found in fields 12-21 and alternate between Match Category and Match Type. Rename the High Net Worth code fields as follows:

Field 12: MC1
Field 13: MT1
Field 14: MC2
Field 15: MT2
Field 16: MC3
Field 17: MT3
Field 18: MC4
Field 19: MT4
Field 20: MC5
Field 21: MT5

*Locate the field that contains the Constituent ID Number and rename that field “ConsID” This is usually Field 1 or Field 2. Also, make sure the data type for the ConsID field is “text”, which must be the same in all tables. This is the Field through which the data will be linked.

### Geodemographic

The Geodemographic Codes used in the PID are: ConsID, Median Household Income, Estimated Household Income, Wealth Rating and Date of Birth. The current location of these fields in the Geodemographic file are:

Field 21: ConsID

Field 26: Date of Birth (DOB)

Field 32: Estimated Household Income (EHHI)

Field 56: Median Household Income (MHHI)

Field 58: Wealth Rating (WR)

### Linking Tables in Database

Before beginning this process, make sure each of the tables in the ACCESS database has a field for Constituent ID. (It is this field that will link all of the tables AND ensure that the data is returned to the proper record #) Also, make sure Constituent ID has the same Data Type in each of the tables.

1. Combine all RE tables (if more than one)

A. Create a relationship between the RE tables Join Properties

Select “includes all rows from Biographical and only those records from Events Table where joined fields are equal” (this is because the Biographical table contains every record in the database and Events Table contains only the records that have captured Event gifts)

Repeat process for the Other Gift and Total Tables

B. Create a query that selects the fields from each RE table you need for analysis. Select all fields from the Biographical table (including the ConsID field) and select the specified gift information from each of the tables.

From the Total Table, select: Largest and Total

From the Total Events Table, select: Total Event

From the Total Annual Fund Table, select: Total Annual Fund

From the Total Capital and Other Table, select: Total Capital and Other

From the Events Table, select: Event 97, Event 98, Event 99 and Total Event 97-99

From the Annual Fund Table, select: Annual Fund 97, Annual Fund 98, Annual Fund 99 and Total Annual Fund 97-99

From the Capital and Other Gift Table, select: Capital and Other 97, Capital and Other 98, Capital and Other 99 and Total Capital and Other 97-99

(Select the ConsID field from the Biographical table only and add only the specified gift information fields from the other tables. It is not necessary to add the ConsID field for each of the tables because the tables have been linked).

Run Query

C. Create a table from the query that includes all RE information

1. Once RE tables are combined, add the following new fields to the RE table in ACCESS

### TWG Fields

AFST—Annual Fund Short Term

AFLT—Annual Fund Long Term

MG—Major Gift

PG—Planned Gift

These fields will contain TWG's target codes.

2. Create relationships between the new combined RE table and the High Net Worth and Geodemographic tables, where the join type is “includes all rows from Biographical and only those records from High Net Worth Table where joined fields are equal” Repeat for Geodemographic Table.

3. Create a QUERY that selects the fields from each of the tables that you will need for analysis

All fields from the Combined RE Table and Fields that were renamed in both the High Net Worth and Geodemographic Tables during import

4. Create a table from the Query created

5. New Table is now ready for analysis

### Criteria for Analysis

### Process and Criteria for Identifying Top Prospects

The purpose is to screen the database for individuals who demonstrate the potential for making annual gifts of $1,000 or more. The top giving candidate pool is defined, in general, as the top 1,000 prospects or the top 7-10 % of a client's audience, whichever is smaller. The default queries for this process are listed below.

Step 1—Create Top Pool

Run a basic query using the following criteria:

| | |
|---|---|
| MEDIAN HOUSEHOLD INCOME (MHHI) | >= $75,000 OR |
| ESTIMATED HOUSEHOLD INCOME | >= 7 AND |
| WEALTH RATING | >= 8 AND |
| P$ycle Code | = 1 |
| TOTAL GIFTS | >= $2,000 OR |
| WealthEngine CODES | >= 1A E OR 1B E OR |
| | 2A E OR 2C E OR |
| | 2D E OR 5A E OR |
| | 5B E OR 5C E |

If total number of records in the combined search lists equals 10% of the client audience of individuals, this group should be considered as the “Top Prospect” pool

Step 2—Modify the Top Pool (if necessary)

### If Pool is Greater Than 10%

If the total number of records in initial search is greater than 10%, using the above search list, run follow-up searches using the same criteria as above but raising the criteria as follows:

| | |
|---|---|
| MHHI | >= $85,000 |

If the total number of records in the search is still greater than 10% of the client audience,

| MHHI | >= $85,000 AND |
|---|---|
| Total Gifts | >= $5000 |

If the total number of records in the search is still greater than 10% of the client audience, make

EHHI=7 AND WR=9 AND P$ycle Code=1

If the total number of records in the search is still greater than 10% of the client audience,

Eliminate the EHHI and WR criteria AND

Make MHHI >=$85,000 AND P$ycle Code=1

If the total number of records in the search is still greater than 10%, proceed with a top prospect pool of greater than 10% but not exceeding 12% of the database.

### If Pool is Less Than 10%

If the total number of records in the search is less than 10%, using the above search list, run follow-up searches using the same criteria above, but lowering the criteria as follows:

| EHHI | >= 6 AND |
|---|---|
| WR | >= 7 AND |
| P$ycle Code | = 1 |

If the total number of records in the search is still less than 10% of the client audience,

MHHI >=$50,000 AND

P$ycle Codes =4 or 5 or 6 or 11

If the total number of records is still less than 10%, proceed with a top prospect pool of less than 10%, but not below 8% of the database.

Optionally, to easily distinguish the top prospect pool from the rest of the database, create a new field in the table called “TOP” and globally update these records by entering “TOP” in this new field to distinguish them from the rest of the database.

### Preliminary Target Code Assignment

### Top Prospect Pool

Run the following queries against the top prospect pool and assign a Short Term Target Code (STTC) according to the following criteria:

| Query | STTC = Ask Amount $15,000 | |
|---|---|---|
| 1) | Total Gift | >= $100,000 OR |
| | Total Gift | >= $25,000 AND |
| | Largest Annual Fund | >= $15,000 in last three years OR |
| | Gift | |
| | Total Capital/Other | >= $25,000 AND |
| | Gifts | |
| | Largest Capital/Other | >= $25,000 |
| | Gift | |
| | Globally assign a STTC of “SH” to this group | |
| Query | STTC = Ask Amount of $10,000 | |
| 2) | Total Gift | >= $10,000 AND |
| | Largest Annual Fund | >= $7,500 in last three years OR |
| | Gift | |
| | Two Annual Gifts of | >= $5,000 in last three years OR |
| | Total Capital/Other | >= $10,000 in the last three years |
| | Gifts | |
| | Globally assign a STTC of “90” to this group | |
| Query | STTC = Ask Amount of $5,000 | |
| 3) | Total Gift | >= $10,000 AND |
| | Largest Annual Fund | >= $3,000 in last three years OR |
| | Gift | |
| | Total Gift | >= $10,000 AND |
| | Two Annual Gifts of | >= $2,500 in last three years OR |
| | Total Capital/Other | >= $7,500 in the last three years OR |
| | Gifts | |
| | Total Gift | <= $100,000 AND |
| | Largest Annual Fund | >= $10,000 prior to the last three years |
| | Gift | |
| | Globally assign a STTC of “80” to this group | |
| Query | STTC = Ask Amount of $2,500 | |
| 4) | Total Gifts | >= $5,000 AND |
| | Largest Annual Fund | >= $1,500 in last three years OR |
| | Gift | |
| | Total Capital/Other | >= $4,000 in the last three years |
| | Gifts | |
| | Globally assign a STTC of “70” to this group | |
| Query | STTC = Ask Amount of $1,500 | |
| 5) | Total Gifts | >= $2,500 AND |
| | Largest Annual Fund | >= $1,000 in last three years OR |
| | Gift | |
| | Total Capital/Other | >= $2,500 in the last three years |
| | Gifts | |
| | Globally assign a STTC of “60” to this group | |
| Query | STTC = Ask Amount of $1,000 | |
| 6) | Total Gifts | >= $2,000 AND |
| | Largest Annual Fund | >= $500 in last three years OR |
| | Gift | |
| | Two Annual Gifts of | >= $500 in last three years OR |
| | Total Capital/Other | >= $2,000 OR |
| | Gifts | |
| | Total Special Event | >= $1,000 in the last three years OR |
| | Gifts | |
| | Total Gift | <= $100,000 AND |
| | Largest Annual Fund | >= $1,000 prior to the last three years |
| | Gift | |

| | |
|---|---|
| | Globally assign a STTC of “50” to this group |
| Query | Remaining Top Prospect records should be individuals who do |
| 7) | not have substantial gift histories but who should be considered |
| | as POTENTIAL $1,000 gift prospects due to geodemographic |
| | and WealthEngine data. |
| | Globally assign a STTC of “54” to this group. |

### Process and Criteria for Electronic Taret Coding not included in the Top Prospect Pool

Run the following series of queries and assign a Short Term Target Code (STTC) of the rest of the file according to the following criteria, making sure that individuals assigned a STTC are drawn from the top prospect pool only.

| Query 1) | STTC = Ask Amount of $500 | |
|---|---|---|
| | Total Gift | >= $1,500 OR |
| | Total Gift | >= $500 AND |
| | Largest Gift | >= $200 in the last three years OR |
| | MHHI | >= $70,000 |
| | Globally update STTC of this group to “40” | |
| Query 2) | STTC = Ask Amount of $250 | |
| | Total Gift | >= $1,000 OR |
| | Total Gift | >= $250 AND |
| | Largest Gift | >= $100 in the last three years OR |
| | MHHI | >= $60,000 |
| | Globally update STTC of this group to “30” | |
| Query 3) | STTC = Ask Amount of $100 | |
| | Total Gift | >= $200 OR |
| | Largest Gift | >= $50 in the last three years OR |
| | MHHI | >= $50,000 |

| | |
|---|---|
| | Globally update STTC of this group to “20” |
| Query 4) | Globally update the remaining individuals in this database to |
| | “10” |

### Short Term Target Code Goals

“54”−“SH”=10% of fund raising database

“20”−“40”=45% of fund raising database

“10”=45% of fund raising database

### Process and Criteria for Electronic Target Coding of Long Term Potential

This step should be implemented only after all Short Term Target Code assignments have been completed and reviewed by the Project Manager.

### Criteria for Assigning Long Term Target Codes

The long term target code is considered an assessment of an individual's giving level in 5 years. Since the assessment of an individual's giving status over the long term is an educated guess, TWG's analysis uses an individual's Short Term Target Code as a base for analyzing long term potential. Long Term Target Codes (LTTC) are assigned according to two basic criteria: 1.) individuals who have made gifts, and; 2.) individuals with no gift history.

Top Prospects

| Query 1) | LTTC = Ask Amount $15,000 | |
|---|---|---|
| | STTC = SH | |
| | Make LTTC = STTC (“SH”) | |
| Query 2) | LTTC = Ask Amount $10,000 | |
| | STTC = 90 | |
| | Make LTTC = STTC (“90”) | |
| Query 3) | LTTC = Ask Amount $10,000 | |
| | STTC | = 80 AND |
| | Total Gift | >= 1 AND |
| | MHHI | >= $75,000 |
| | Make LTTC = STTC plus 1 level to “90” OR | |
| | Remaining individuals that do not match above criteria | |
| | Make LTTC = STTC (“80”) | |
| Query 4) | LTTC = Ask Amount $10,000 | |
| | STTC | = 70 AND |
| | Total Gift | >= 1 AND |
| | MHHI | >= $75,000 |
| | Make LTTC = STTC plus 2 levels to “90” OR | |
| | LTTC = Ask Amount $5,000 | |
| | STTC | = 70 AND |
| | Total Gift | >= 1 AND |
| | MHHI | <= $74,999 |
| | Make LTTC = STTC plus 1 level to “80” OR | |
| | Remaining individuals that do not match above criteria | |
| | Make LTTC = STTC (“70”) | |
| Query 5) | LTTC = Ask Amount $5,000 | |
| | STTC | = 60 AND |
| | Total Gift | >= 1 AND |
| | MHHI | >= $75,000 |
| | Make LTTC = STTC plus 2 levels to “80” OR | |
| | LTTC = Ask Amount $2,500 | |
| | STTC | = 60 AND |
| | Total Gift | >= 1 AND |
| | MHHI | <= $74,999 |
| | Make LTTC = STTC plus 1 level to “70” OR | |
| | Remaining individuals that do not match above criteria | |
| | Make LTTC = STTC (“60”) | |
| Query 6) | LTTC = Ask Amount $2,500 | |
| | STTC | = 50 AND |
| | Total Gift | >= 1 AND |
| | MHHI | >= $75,000 |
| | Make LTTC = STTC plus 2 levels to “70” OR | |
| | LTTC = Ask Amount $1,500 | |
| | STTC | = 50 AND |
| | Total Gift | >= 1 AND |
| | MHHI | <= $74,999 |
| | Make LTTC = STTC plus 1 level to “60” OR | |
| | Remaining individuals that do not match above criteria | |
| | Make LTTC = STTC (“50”) | |
| Query 7) | LTTC = Ask Amount $1,500 | |
| | STTC | = 54 AND |
| | Total Gift | >= 1 AND |
| | MHHI | >= $75,000 |

| | |
|---|---|
| | Make LTTC = STTC plus 2 levels to “60” |
| Query 8) | Remaining individuals that do not match the above criteria |
| | Make LTTC = STTC plus 1 level to “50” |

Lower 90%

| Query 1) | LTTC = Ask Amount $1,500 | |
|---|---|---|
| | STTC | = 40 AND |
| | Total Gift | >= 1 AND |
| | MHHI | >= $75,000 |
| | Make LTTC = STTC plus 2 levels to “60” | |
| | LTTC = Ask Amount $1,500 | |
| | STTC | = 40 AND |
| | Total Gift | >= 1 AND |
| | MHHI | >= $50,000 AND |
| | P$ycle Codes | = 4 or 5 or 6 or 11 |
| | Make LTTC = STTC plus 2 levels to “60” | |
| | LTTC = Ask Amount $1,500 | |
| | STTC | = 40 AND |
| | Total Gift | >= 1 AND |
| | EHHI | = 7 AND |
| | WR | = 9 AND |
| | P$ycle Codes | = 4 or 5 or 6 or 11 |
| | Make LTTC = STTC plus 2 levels to “60” OR | |
| | LTTC = Ask Amount $1,000 | |
| | STTC | = 40 AND |
| | Total Gift | >= 1 AND |
| | MHHI | <= $74,999 |
| | Make LTTC = STTC plus 1 level to “50” OR | |
| | LTTC = Ask Amount $1,000 | |
| | STTC | = 40 AND |
| | Total Gift | = 0 or is null AND |
| | MHHI | >= $75,000 |
| | Make LTTC = STTC plus 1 level to “50” OR | |
| | LTTC = Ask Amount $1,000 | |
| | STTC | = 40 AND |
| | Total Gift | >= $1,000 AND |
| | MHHI | Is Null |
| | Make LTTC = STTC plus 1 level to “50” OR | |
| | LTTC = Ask Amount $1,000 | |
| | STTC | = 40 AND |
| | Total Gift | = 0 or is null AND |
| | MHHI | >= $50,000 |
| | P$ycle Codes | = 4 or 5 or 6 or 11 |
| | Make LTTC = STTC plus 1 level to “50” OR | |
| | LTTC = Ask Amount $1,000 | |
| | STTC | = 40 AND |
| | Total Gift | = 0 or is null AND |
| | EHHI | = 7 AND |
| | WR | = 9 AND |
| | P$ycle Codes | = 4 or 5 or 6 or 11 |
| | Make LTTC = STTC plus 1 level to “50” OR | |
| | LTTC = Ask Amount $1,000 | |
| | STTC | = 40 AND |
| | Total Gift | >= 1 AND |
| | EHHI | >= 6 AND |
| | WR | >= 8 AND |
| | P$ycle Codes | = 4 or 5 or 6 or 11 |
| | Make LTTC = STTC plus 1 level to “50” OR | |
| | Remaining individuals that do not match above criteria | |
| | Make LTTC = STTC (“40”) | |
| Query 2) | LTTC = Ask Amount $1,000 | |
| | STTC | = 30 AND |
| | Total Gift | >= 1 AND |
| | MHHI | >= $75,000 |
| | Make LTTC = STTC plus 2 levels to “50” OR | |
| | LTTC = Ask Amount $1,000 | |
| | STTC | = 30 AND |
| | Total Gift | >= 1 AND |
| | MHHI | >= $40,000 AND |
| | P$ycle Codes | = 4 or 5 or 6 or 11 |
| | Make LTTC = STTC plus 2 levels to “50” OR | |
| | LTTC = Ask Amount $1,000 | |
| | STTC | = 30 AND |
| | Total Gift | >= 1 AND |
| | EHHI | >= 6 AND |
| | WR | >= 8 AND |
| | P$ycle Codes | = 4 or 5 or 6 or 11 |
| | Make LTTC = STTC plus 2 levels to “50” OR | |
| | LTTC = Ask Amount $500 | |
| | STTC | = 30 AND |
| | Total Gift | >= 1 AND |
| | MHHI | <= $74,999 |
| | Make LTTC = STTC plus 1 level to “40” OR | |
| | LTTC = Ask Amount $500 | |
| | STTC | = 30 AND |
| | Total Gift | = 0 or is null AND |
| | MHHI | >= $75,000 |
| | Make LTTC = STTC plus 1 level to “40” OR | |
| | LTTC = Ask Amount $500 | |
| | STTC | = 30 AND |
| | Total Gift | = 0 or is null AND |
| | MHHI | >= $40,000 |
| | P$ycle Codes | = 4 or 5 or 6 or 11 |
| | Make LTTC = STTC plus 1 level to “40” OR | |
| | LTTC = Ask Amount $500 | |
| | STTC | = 30 AND |
| | Total Gift | = 0 or is null AND |
| | EHHI | >= 6 AND |
| | WR | >= 8 AND |
| | P$ycle Codes | = 4 or 5 or 6 or 11 |
| | Make LTTC = STTC plus 1 level to “40” OR | |
| | Remaining individuals that do not match above criteria | |
| | Make LTTC = STTC (“30”) | |
| Query 3) | LTTC = Ask Amount $500 | |
| | STTC | = 20 AND |
| | Total Gift | >= 1 AND |
| | MHHI | >= $50,000 |
| | Make LTTC = STTC plus 2 levels to “40” OR | |
| | LTTC = Ask Amount $500 | |
| | STTC | = 20 AND |
| | Total Gift | >= 1 AND |
| | MHHI | >= $40,000 AND |
| | P$ycle Codes | = 4 or 5 or 6 or 11 |
| | Make LTTC = STTC plus 2 levels to “40” OR | |
| | LTTC = Ask Amount $500 | |
| | STTC | = 20 AND |
| | Total Gift | >= 1 AND |
| | EHHI | >= 6 AND |
| | WR | >= 8 AND |
| | P$ycle Codes | = 4 or 5 or 6 or 11 |
| | Make LTTC = STTC plus 2 levels to “40” OR | |
| | LTTC = Ask Amount $250 | |
| | STTC | = 20 AND |
| | Total Gift | >= 1 AND |
| | MHHI | <= $49,999 |
| | Make LTTC = STTC plus 1 level to “30” OR | |
| | LTTC = Ask Amount $250 | |
| | STTC | = 20 AND |
| | Total Gift | = 0 or is null AND |
| | MHHI | >= $50,000 |
| | Make LTTC = STTC plus 1 level to “30” OR | |
| | LTTC = Ask Amount $250 | |
| | STTC | = 20 AND |
| | Total Gift | = 0 or is null AND |
| | MHHI | >= $40,000 |
| | P$ycle Codes | = 4 or 5 or 6 or 11 |
| | Make LTTC = STTC plus 1 level to “30” OR | |
| | LTTC = Ask Amount $250 | |
| | STTC | = 20 AND |
| | Total Gift | = 0 or is null AND |
| | EHHI | >= 6 AND |
| | WR | >= 8 AND |
| | P$ycle Codes | = 4 or 5 or 6 or 11 |
| | Make LTTC = STTC plus 1 level to “30” OR | |
| | Remaining individuals that do not match above criteria | |
| | Make LTTC = STTC (“20”) | |
| Query 4) | LTTC = Ask Amount $250 | |
| | STTC | = 10 AND |
| | Total Gift | >= 1 AND |
| | MHHI | >= $50,000 |
| | Make LTTC = STTC plus 2 levels to “30” OR | |
| | LTTC = Ask Amount $250 | |
| | STTC | = 10 AND |
| | Total Gift | >= 1 AND |
| | MHHI | >= $40,000 AND |
| | P$ycle Codes | = 4 or 5 or 6 or 11 |
| | Make LTTC = STTC plus 2 levels to “30” OR | |
| | LTTC = Ask Amount $250 | |
| | STTC | = 10 AND |
| | Total Gift | >= 1 AND |
| | EHHI | >= 6 AND |
| | WR | >= 8 AND |
| | P$ycle Codes | = 4 or 5 or 6 or 11 |
| | Make LTTC = STTC plus 2 levels to “30” OR | |
| | LTTC = Ask Amount $100 | |
| | STTC | = 10 AND |
| | Total Gift | >= 1 AND |
| | MHHI | <= $49,999 |
| | Make LTTC = STTC plus 1 level to “20” OR | |
| | LTTC = Ask Amount $100 | |
| | STTC | = 10 AND |
| | Total Gift | = 0 or is null AND |
| | MHHI | >= $50,000 |
| | Make LTTC = STTC plus 1 level to “20” OR | |
| | LTTC = Ask Amount $100 | |
| | STTC | = 10 AND |
| | Total Gift | = 0 or is null AND |
| | MHHI | >= $40,000 |
| | P$ycle Codes | = 4 or 5 or 6 or 11 |
| | Make LTTC = STTC plus 1 level to “20” OR | |
| | LTTC = Ask Amount $100 | |
| | STTC | = 10 AND |
| | Total Gift | = 0 or is null AND |
| | EHHI | >= 6 AND |
| | WR | >= 8 AND |
| | P$ycle Codes | = 4 or 5 or 6 or 11 |

Make LTTC = STTC plus 1 level to “20” OR
Remaining individuals that do not match above criteria
Make LTTC = STTC (“10”)

Long Term Target Code Goals

| “50”-“SH” = | 13% of the fund raising database |
|---|---|
| “20”-“30” = | 49% of the fund raising database |
| “10” = | 38% of the fund raising database |

### Process and Criteria for Identifying Major Gift Prospects

PURPOSE: To screen the database for individuals who demonstrate the potential for making a one time gift of $50,000 or more.

### Major Gift Code Assignment

Run the following queries and assign a Major Gift Code (MGC) according to the following criteria:

| Query 1) | MGC = High Affluence and High Affinity | |
|---|---|---|
| | Total Gift | >= $20,000 AND |
| | Largest Gift | >= $5,000 AND |
| | AFST | >= 50 OR |
| | Largest Gift | >= $10,000 AND |
| | AFST | >= 50 |
| | Globally assign a MGC of “A” to this group | |
| Query 2) | MGC = High Affluence and Moderate Affinity | |
| | Total Gift | >= $10,000 AND |
| | Largest Gift | >= $2,500 AND |
| | AFST | >= 50 OR |
| | MHHI | >= $125,000 AND |
| | Total Gift | >= $1000 AND |
| | AFST | >= 50 |
| | Globally assign a MGC of “B” to this group | |
| Query 3) | MGC = High Affluence and Low Affinity | |
| | MHHI | >= $125,000 AND |
| | AFST | >= 50 OR |
| | POW&R | = 1AE OR 1BE OR 2AE OR |
| | MHHI | >= $100,000 AND |
| | Total Gifts | >= $1,000 AND |
| | P$ycle Codes | = 4 or 5 or 6 or 11 AND |
| | AFST | >= 50 OR |
| | P$ycle Code | = 1 AND |
| | AFST | >= 50 |

| | |
|---|---|
| | Globally assign a MGC of “C” to this group |
| Query 4) | MGC = High Affluence and Research Affinity |
| | WealthEngine Matches in top categories without a major gift |
| | code [any Match type] |
| | (1A, 1B, 2A, 2C, 2D, 5A, 5B, OR 5C) |
| | Globally assign a STTC of “R” to this group OR |
| | P$ycle Codes 4 or 5 or 6 or 11 AND |
| | In the top prospect pool OR |
| | P$ycle Code 1 |

### Major Gift Target Code Goals

“A”=b 1% of the fund raising database

“B”=1% of the fund raising database

“C”=2% of the fund raising database

“R”=3% of the fund raising database

### Process and Criteria for Identifying Planned Gift Prospects

PURPOSE: To screen the database for individuals who demonstrate the potential and are age appropriate for making a planned gift of $50,000 or more.

### Planned Gift Code Assignment

Run the following queries and assign a Planned Gift Code (PGC) according to the following criteria:

Query 1) PGC High Affluence and High Affinty

| | | |
|---|---|---|
| Total Gift | >= $15,000 | AND |
| Age | >= 55 | AND |
| Age | = not “U” | OR |
| Largest Gift | >= $10,000 | AND |
| Age | >= 55 | AND |
| Age | = not “U” | OR |
| Total Gift | >= $15,000 | AND |
| P$ycle Codes | = 2 OR 3 | AND |
| DOB | = U or is null | OR |
| Largest Gift | >= $10,000 | AND |
| P$ycle Codes | >= 2 OR 3 | AND |
| DOB | = U or is null | |

Globally assign a PGC of “A” to this group

Query 2) PGC = High Affluence and Moderate Affinity

| | | | |
|---|---|---|---|
| Total Gift | >= $10,000 | AND | Age 55+ and not “U” OR |
| MHHI | >= $100,000 | AND | Age 55+ and not “U” AND |
| Total Gift | >= $1,000 | OR | |
| Total Gift | >= $10,000 | AND | DOB is null or “U” AND |
| P$ycle Codes | = 2 or 3 | | OR |
| MHHI | >= $100,000 | AND | |
| Total Gift | >= $1,000 | AND | |
| P$ycle Codes | = 2 or 3 | | |

Globally assign a PGC of “B”to this group

Query 3) PGC = High Affluence and Low Affinity

| | | |
|---|---|---|
| Age 55+ and not “U” | AND | Top Prospect Pool OR |
| P$ycle Codes | = 2 or 3 | AND |
| Total Gift | >= 1 | AND |
| MHHI | >= $75,000 | OR |
| P$ycle Code | = 1 | AND |
| Age 55+ and not “U” | AND | |
| Total Gift | >= 1 | AND |
| MHHI | >= $75,000 | |

Globally assign a PGC of “C” to this group

Query 4) PGC = High Affluence and Research Affinity

| | |
|---|---|
| MGC “R” where | Age 55+ and not “U” OR |
| P$ycle Code = 1 | AND Age >= 55 and not “U” OR |
| P$ycle Code = 2 or 3 | |

Globally assign a PGC of “R” to this group

### Planned Gift Target Code Goals

“A”=<1 % of the fund raising database

“B”=1 % of the fund raising database

“C”=4 % of the fund raising database

“R”=4 % of the fund raising database

### Import Analysis Codes for Constituent Attribute Tab

Once the PID analysis has been completed in Access, the new/updated data is installed on the original client-donee database.

### Data Preparation

To install the data, 4 steps must be taken to prepare it:

1. In the Access database created for the PID analysis, a new table called “Lookup Table” is created. This table will add information that will define and describe the target codes that have been assigned to each record during the PID analysis. This table will include the following three fields:

| | |
|---|---|
| CATCat: | name of target code (e.g.: “Major Gift Code”) |
| CATDesc: | TWG's assigned target code |
| CATComment: | definition of target code (e.g.: “high affluence |
| | and moderate affinity” or “$100 to 249”) |

In the CATDesc field, every possible target code (e.g.: 10, 20, 30, A, B, C, etc.) is entered, for each field planned to be imported. For example, “10” must be added twice, once for Annual Fund Short Term and once for Annual Fund Long Term, and “A” must be entered twice, once for Major Gift Code and once for Planned Gift Code, etc.) There should be 30 records total in this table for these four target codes, one record for each description. (including 2 records for Special Handling Codes)

In the CATCat and CATComment Fields, the information entered must correspond with the information in the CATDesc field. For example,

| CATCat | CATDesc | CATComment |
|---|---|---|
| Major Gift Code | A | high affluence and high affinity |
| Annual Fund Short Term | 80 | $5,000 to $9,999 |
| Annual Fund Long Term | 90 | $10,000 or more |
| Planned Gift Code | A | high affluence and high affinity |

2. A query that joins the “Main Table” [the table that contains the entire PID analysis] to the “Lookup Table” is created. This join is made between the field that information is to be added to and the information being added.

Select all of the fields in the “Lookup Table” and from the “Main Table”, select the Constituent ID field

In the criteria row for the CATCatfield, type: Like “Major Gift Code”

Run Query

The result is a list of every record in the database that contains information specified in the Query (For Example, in the Major Gift Code Query, the number of records must equal the number of major gift codes assigned during analysis.)

This same Query is created for each of the fields that are to be imported onto the original database. [e.g. Major Gift Code, Planned Gift Code, Annual Fund Short Term, Annual Fund Long Term, Membership Short Term, Membership Long Term]

3. Create a UNION query that combines each of these new queries.

For example, in the SQL view in the query tab, the following may be typed:

SELECT * FROM [name of query #1]

UNION

SELECT * FROM [query #2]

UNION

SELECT * FROM [query #3]

UNION

SELECT * FROM [query #4];

The result should be a query that has the information from all of the fields that will be imported onto the original RE database. It should be noted that there will be more than one record for individual records that have been given more than one target code. For example,

| ConsID | CATCat | CATDesc | CATComment |
|---|---|---|---|
| 101 | Major Gift Code | A | high affluence and |
| | | | high affinity |
| 101 | Annual Fund Short Term | 80 | $5,000 to $9,999 |
| 101 | Annual Fund Long Term | 90 | $10,000 or more |
| 101 | Planned Gift Code | A | high affluence and high |
| | | | affinity |
| 102 | Annual Fund Short Term | 10 | $1 to 99 |
| 102 | Annual Fund Long Term | 30 | $250 to 499 |
| 103 | Annual Fund Short Term | 30 | $250 to 499 |
| 103 | Annual Fund Long Term | 50 | $1,000 to 2,499 |

4. Export the Union query from Access to a text file.

Import this data to the database of the program.

After your RE database has been backed-up, open RE Configuration

Click Attributes Tab

Select Constituent

In the Description Field, enter “Annual Fund Short Term”

In the Data Type field, select “Table”

In Table Name Field, select “add new table” and choose “Annual Fund Short Term”

[Repeat this same process for the three other categories: Annual Fund Long Term, Major Gift Code, Planned Gift Code]

### Exit Configuration

Open RE Database Administration

Select File

Select Import

File Name: click on browse on the right end of this box. Locate Drive and folder

Select the name of the export file

| | |
|---|---|
| OK | |
| Import type: | Click on scroll arrow and select Constituent |
| | Attribute |
| Operation: | Select Import |
| RE Field Mapping: | Select Header Record |
| Constituent ID/Keys: | Select Constituent ID |
| Exceptions: | Select Automatically create new table entries |
| | Exception file: choose name/destination for a |
| | file that will store |
| | any exceptions to the import |
| OK | |

When process complete, all new information is now on the RE database, under the Attributes Tab, in Constituent Management.

### Import Analysis Codes for the Prospect Research Tab

Once the PID analysis has been completed in Access, the new/updated data must be installed on the original client—donee database.

### Data Preparation

To install the data, 4 steps must be taken to prepare it:

1. In the Access database created for the PID analysis, a new table called “Lookup Table”is created. This table will add information that will define and describe the target codes that have been assigned to each record during the PID analysis. This table will include the following four fields:

| | |
|---|---|
| Category: | TWG's assigned target code |
| Description: | name of target code (e.g.: “Major Gift Code”) |
| Notes: | definition of target code (e.g.: “high affluence and moderate |
| | affinity” or “$100 to 249”) |
| Date: | date PID analysis completed |

In the Category field, every possible target code (e.g.: 10, 20, 30, A, B, C, etc.) is entered for each field that is imported. There should be 30 records total in this table for these four target codes, one record for each description. (including 2 records for Special Handling Codes)

In the Description and Notes Fields, the information entered must correspond with the information in the Category field. For example,

| Description | Category | Notes | Date |
|---|---|---|---|
| Major Gift Code | A | high affluence and | 12/1/99 |
| | | high affinity | |
| AF Short Term | 80 | $5,000 to $9,999 | 12/1/99 |
| AF Long Term | 90 | $10,000 or more | 12/1/99 |
| Planned Gift Code | A | high affluence and | 12/1/99 |
| | | high affinity | |

2. A query that joins the “Main Table” [the table that contains the entire PID analysis] to the “Lookup Table” is created. This join is made between the field that information is to be added to and the information being added. For example, click on the Major Gift Code field (the field that contains A, B, C or R) in the “Main Table” and drag it to the Category field on the “Lookup Table”. A line between these two fields should now appear, indicating that the join has been made.

Select all of the fields in the “Lookup Table” and from the “Main Table”, select the Constituent ID field.

In the criteria row for the Description field, type: Like “Major Gift Code”

Run Query

The result is a list of every record in the database that contains information specified in the Query.

Create this same Query for each of the fields that is imported onto the original database. [e.g. Major Gift Code, Planned Gift Code, Annual Fund Short Term, Annual Fund Long Term, Membership Short Term, Membership Long Term]

3. A UNION query that combines each of these new queries is created.

This can be done by:

In the SQL view, type the following exactly as follows:

SELECT * FROM [name of query #1]

UNION

SELECT * FROM [query #2]

UNION

SELECT * FROM [query #3]

UNION

SELECT * FROM [query #4];

The result should be a query that has the information from all of the fields that will be imported onto the original RE database. For example,

| | PRDesc | | |
|---|---|---|---|
| ConsID | PRDt | PRValue | PRNotes |
| 101 | Major Gift Code | A | high affluence and high |
| | 12/1/99 | | affinity |
| 101 | AFShortTerm | 80 | $5,000 to $9,999 |
| | 12/1/99 | | |
| 101 | AF Long Term | 90 | $10,000 or more |
| | 12/1/99 | | |
| 101 | PG Code | A | high affluence and high |
| | 12/1/99 | | affinity |
| 102 | AF ShortTerm | 10 | $1 to 99 |
| | 12/1/99 | | |
| 102 | AF Long Term | 30 | $250 to 499 |
| | 12/1/99 | | |
| 103 | AF Short Term | 30 | $250 to 499 |
| | 12/1/99 | | |
| 103 | AF Long Term | 50 | $1,000 to 2,499 |
| | 12/1/99 | | |

4. Export the Union query from Access to a text file. (Access files cannot be imported directly onto the program, but must be first saved as a text file).

### Access Export

Right Click on the Union query

Select Save As/Export

Select To an External File or Database OK

Select a destination for this export. Change file type from Microsoft Access (.mdb) to a Text file (.txt)

Choose the current folder and rename the file. The file name should have no spaces and be no longer than 8 characters and should have the file extension .txt (e.g.: exportl.txt)

Click Export

The Export Text Wizard will appear:

Select Delimited, click Next

Select INCLUDE FIELD NAMES ON FIRST ROW

Select [“] as the text qualifier NEXT

Export to file: file location and name, FINISH

When export is finished, click OK

The next file will be saved in its new destination

Now this is imported onto the database of the program.

In RE, open RE Database Administration

Select File

Select Import

File Name: click on browse on the right end of this box. Locate the drive and folder

Select the file name (export1.txt) OK

| | |
|---|---|
| Import Type: | Click on scroll arrow and select Prospect Rating |
| Operation: | Select Import |
| RE Field Mapping: | Select Header Record |
| Constituent ID/Keys: | Select Constituent ID |
| Exceptions: | Select Automatically create new table entries |

Exception file: choose name/destination for a file that will store any exceptions to the import

OK

When process complete, all new information is now on the RE database, under the “Prospect Tab: Ratings”, in Constituent Management.

The following is an example of a geodemographic request for information that may be used with the present invention.

Dear______,

As discussed, I have attached the file we would like to have information appended to. This file contains xxxx records. Please email the appended file to me (the file must be zipped) The record layout is as follows:

1. ID—20 characters

2. Constituent ID—20 characters

3. Last Name—50 characters

4. First Name—50 characters

5. Middle Name—50 characters

6. Prefix 1—30 characters

7. Prefix 2—20 characters

8. Suffix 1—30 characters

9. Suffix 2—20 characters

10. Address Line 1—50 characters

11. Address Line 2—50 characters

12. Address Line 3—50 characters

13. Address Line 4—50 characters

14. Address Line 5—50 characters

15. Home City—50 characters

16. Home State—10 characters

17. Home Zip—10 characters

18. Field 18—20 characters

19. Business Name—50 characters

20. Business Position—50 characters

21. Consitutency Code 1—50 characters

22. Consituency Code 2—50 characters

| | | | | Vender | |
|---|---|---|---|---|---|
| Data Element | Field Size | Field Type | Sample Output | Code | Note |
| Exact Date of Birth | 2 digits | Numeric | 68 | 100 | “68” = 1968 |
| Wealth Rating | 1 Digit | Numeric | 9 | 302 | Rating Scale 1-9 |
| Median Household Income | 5 or 6 digits | Numeric | 109,000 | 300 stripped | 2 or 3 digits; appe |
| | | | | | $150,000 |
| Estimated Household Income | 1 digit | Numeric | 6 | 105 | Rating Scale 1-7 |
| P$cyle | 1 or 2 digits | Numeric | 11 | 213 | Categories 1-11 o |

The following is an example of a high net worth overlay request that may be used in the practice of the present invention

Dear______,

Could you please conduct the high net worth overlay for the attached file of XXXX records? I understand that the price will be $XX/match and to expect around XXX matches at a cost of $XXX.

I would like the data returned to me in the file format specified below—with each match category separated into a distinct field, with the match type in the field next to it. i.e.,

Field 1 ConsID

Field 2 (Last Name)

Field 3 (First Name)

Field 4: 1A

Field 5: Match 1

Field 6: 1B

Field 7: Match 2

Field 8: 2A

Field 9: Match 3

Field 10: 2B

Field 11: Match 4

Field 12: 2C

Field 13: Match 5

Field 14: 2D

Field 15: Match 6

Field 16: 3A

Field 17: Match 7

Field 18: 3B

Field 19: Match 8

Field 20: 3C

Field 21: Match 9

Field 22: 3D

Field 23: Match 10

Field 24: 3E

Field 25: Match 11

Field 26: 3F

Field 27: Match 12

Field 28: 4A

Field 29: Match 13

Field 30: 4B

Field 31: Match 14

Field 32: 4C

Field 33: Match 15

Field 34: 4D

Field 35: Match 16

Field 36: 4E

Field 37: Match 17

Field 38: 4F

Field 39: Match 18

Field 40: 5A

Field 41: Match 19

Field 42: 5B

Field 43: Match 20

Field 44: 5C

Field 45: Match 21

Field 46: 5D

Field 47: Match 22

Field 48: 5E

Field 49: Match 23

Field 50: 6A

Field 51: Match 24

Field 52: 6B

Field 53: Match 25

Field 54: 6C

Field 55: Match 26

Field 56: 6D

Field 57: Match 27

The attached file is a .csv file which is zipped. Please return the appended information in the same format or in Access 97 (.mdb). The file must be zipped.

The record layout is as follows:

1. ID—20 characters

2. Constituent ID—20 characters

3. Last Name—50 characters

4. First Name—50 characters

5. Middle Name—50 characters

6. Prefix 1—30 characters

7. Prefix 2—20 characters

8. Suffix 1—30 characters

9. Suffix 2—20 characters

10. Address Line 1—50 characters

11. Address Line 2—50 characters

12. Address Line 3—50 characters

13. Address Line 4—50 characters

14. Address Line 5—50 characters

15. Home City—50 characters

16. Home State- 10 characters

33. Home Zip—10 characters

17. Field 18—20 characters

18. Business Name—50 characters

19. Business Position—50 characters

20. Consitutency Code 1—50 characters

42. Consituency Code 2—50 characters

### Data Import Instructions

The Following Are Representative Instructions for Importing Data from the External Database or Bases

When the study is complete, the data will be sent to you on a disk or via e-mail. Essentially you will be adding 4 new fields to your fund raising software. Each individual's unique identification number is used to link the new data to the existing record.

1. Data Import

There are two files—“dmcodes.txt” and “rawdata.txt” Both files are comma delimited text files and contain the column names in the first row. Save the text files you have just received to a location on the computer.

Next, BACK UP YOUR FUND RAISING SOFTWARE SYSTEM

In order to simplify the import, we have placed these codes in the following four columns:

Unique ID (i.e., “20860031”—the identification number that links the information for each constituent back to the individual's record on your fund raising system. Please change the name for this column to the name that is used by your fund raising software.)

Data Name—the data category (i.e., “Major Gift Code”)

Data Code—assigned to each specific data element (i.e., “A”)

Data Description—defines the data code (i.e., “high affluence and high affinity)

Choose a location on your fund raising software system that will allow you to use the information as criteria and output for your reports and mailings and add the above four column names as new fields in your software exactly as they appear above. Import the file.

* Please note that exceptions are records that have not been imported onto your database. It is not unusual to have a low number of exceptions—this usually occurs because some records might have been deleted or somehow altered. However, if several or all of the records are exceptions, the import has not been properly completed. Review the installation instructions again and make sure all steps were followed accurately.

To ensure that the information has been properly imported, pull up a couple of individual records and review the information.

**Please note that each individual should have at least two new codes on their record—a code for Annual Fund Short Term and Annual Fund Long Term.

### Additional Alternative Import Instructions

When the study is complete, the data will be sent to you on a disk or via e-mail. There are four Smart Codes—Major Gift, Planned Gift, Annual Fund Short Term and Annual Fund Long Term. Essentially you will be adding 4 new fields to your constituent attributes. Each individual's unique identification number is used to link the new data to the existing record.

2. Raiser's Edge

Save the text file containing the Smart Codes (dmcodes.txt) to a location on the computer.

Next, BACK UP YOUR RAISER'S EDGE SYSTEM

After your RE database has been backed-up, open RE Configuration

Click Attributes Tab

Select Constituent

In the Description Field, enter “Annual Fund Short Term”

In the Data Type field, select “Table”

In Table Name Field, select “add new table” and choose “Annual Fund Short Term”

[Repeat this same process for the three other categories: “Annual Fund Long Term”, “Major Gift Code”, “Planned Gift Code”]

### Exit Configuration

Open RE Database Administration

Select File

Select Import

File Name: Click on “browse” on the right end of this box. Locate Drive and folder where the text file has been saved

Select the name of the import file (i.e.,: dmimport.txt)

| | |
|---|---|
| Select “OK” | |
| Import type: | Click on the scroll arrow and select Constituent |
| | Attribute |
| Operation: | Select Import to the Raiser's Edge |
| RE Field Mapping: | Select Header Record |
| Constituent ID/Keys: | Select Constituent ID |
| Exceptions: | Select Automatically create new table entries |
| | Exception file: choose name/destination for a |
| | file that will store any exceptions to |
| | the import |
| Select “OK” | |

The next prompt box will indicate the status of the import as it is importing, including the elapsed time, any exceptions*, and the percentages of files processed.

* Please note that exceptions are records that have not been imported onto your database. It is not unusual to have a low number of exceptions—this usually occurs because some records might have been deleted or somehow altered. However, if several or all of the records are exceptions, the import has not been properly completed. Review the installation instructions again and make sure all steps were followed accurately.

When process complete is, all new information will now be located on the RE database, under the “Attributes” Tab, in Constituent Management.

### Instructions for Importing Raw Data onto Raiser's Edge

Once the Smart Codes are installed, you can install the additional data elements located on the second file returned to you (rawdata.txt), onto your Raiser's Edge database.

Open RE Configuration

Click Attributes Tab

Select Constituent

In the Description Field, enter “Household Income”

In the Data Type field, select “Table”

In the Table Name Field, select “add Table Name” and choose “Household Income”

Hit Enter to proceed to the next row

Repeat this process for the following 4 categories:

Fortune Finder

Date of Birth

Affluence & Affinity

Scale of Affluence

### Exit Configuration

Open RE Database Administration

Select File

Select Import

File Name: click on browse on the right end of this box. Locate Drive and folder

Select the name of the export file (i.e., rawdata.txt) OK

| | |
|---|---|
| Import Type: | Click on scroll arrow and select Constituent |
| | Attribute |
| Operation: | Select Import to The Raiser's Edge |
| RE Field Mapping: | Select Use Header Record |
| Constituent ID/Keys: | Select Constituent ID |
| Exceptions: | Select Automatically create new table entries |
| | Exception file: choose name/destination for a |
| | file that will store any exceptions to the import |
| | OK |

The next prompt box will indicate the status of the import as it is importing, including the elapsed time, any exceptions, and the percentages of files processed.

When the process is complete, all new information is now on the RE database, under the Attributes Tab, in Constituent Management.

To ensure that the information has been properly imported, pull up a couple of individual records and view the information on their constituent attribute tab.

**Please note that each individual should have at least three new codes on their Constituent Attribute tab—a code for Annual Fund Short Term, Annual Fund Long Term and Affluence & Affinity. Only the top prospects will have a Major Gift or Planned Gift Code and only individuals with a match will have additional data appended.

When you view the information in Constituent Management . . . congratulations, you have successfully imported Smart Codes and additional data.

The foregoing description of the applicant's interactive system for facilitating and improving prospect identification and gift targeting is illustrative only and many modifications may be made without departing from the scope of the invention as claimed below.

I claim

1. An apparatus for improving prospect identification and facilitating dollar specific gift targeting comprising a central data processor for storing, indexing and manipulating data, a memory means for storing and selectively retrieving specific portions of a client database specified by a user request, a communication link to establish a communication path between the central data processor and one or more external databases in response to a user request, a prospect data processor for selectively generating data categorized by the giving potential and interest of individuals on the client database, and analysis storage and retrieval means for storing and retrieving selected prospect data.

2. An apparatus for improving prospect identification and facilitating dollar specific gift targeting comprising a central data processor for storing, indexing and manipulating data, a memory means for storing and selectively retrieving specific portions of a client database specified by a user request, a communication link to establish a communication path between the memory means and an external database said in response to a user request, a prospect profile data processor for selectively generating prospect profile data, and analysis storage and retrieval means for storing and retrieving selected prospect profile data.

3. A system for improving prospect identification and facilitating dollar specific gift targeting comprising a first database comprising data of entities supplied by a client, a central data processor for manipulating the data, said central data processor being adapted to selectively accesses data from a second database that provides data about an entity supplied by the client, said central processing unit being adapted to link information in said second database to said data of entities supplied by the client and to express the combined data in accordance with a desired criterion.

4. The system according to claim 3 wherein the client provides the database containing data of entities.

5. The system according to claim 3 wherein the database comprises data of entities includes persons who have made contributions in the past.

6. The system according to claim 3 wherein the central processing unit has selectively addressable memory capable of storing digital data.

7. The system according to claim 6 wherein the central processing unit is a network of computers.

8. The system according to claim 3 wherein the data provided by the client is read and information pertaining to each entity is linked with a unique identification number and wherein the central processing unit maintains the database that provides external information about each entity to which the record pertains.

9. The system according to claim 3 wherein the database that provides external information about each entity to which the record pertains is one or more external databases.

10. A method for improving prospect identification and facilitating dollar specific gift targeting comprising
providing a first database containing data of an entity supplied by a client, importing the data from the database into a central processing unit, accessing a second database that provides external information about an entity in said first database,
transmitting a query from said central processing unit to said second database that links external information about each entity,
searching said second database,
importing the data generated in response to the search to the central processing unit,
linking the data generated in response to the search to the data of said entity in the first database,
expressing the linked data in accordance with a desired criterion.

11. The method according to claim 10 wherein the central processing unit has selectively addressable memory capable of storing digital data.

12. The method according to claim 11 wherein the central processing unit comprises a network of computers linked together.

13. The method according to claim 10 wherein a unique identification number is assigned to each of record of data concerning an entity in the first database is used by the central processing unit to selectively access against each record from the first database, data from said second database.

14. The method according to claim 13 wherein the second database is one or more external databases.

15. The method according to claim 11 wherein the process is repeated for a plurality of entities and the entire data compiled is divided into groups in accordance with certain criteria.

16. The method according to claim 15 wherein dollar specific and gift giving codes are generated and assigned to each record, based on data provided by the external database and the database provided by the client.

17. The method according to claim 16 wherein the data is divided into groups and is formatted for installation onto the client database.

18. The method according to claim 16 wherein the client is provided with access to the data generated via electronic means.

19. The apparatus according to claim 1 further comprising an export facility for returning generated data to the client database.

20. The apparatus according to claim 2 further comprising an export facility for returning generated data to the client database.

21. The system according to claim 3 wherein the database comprises data of entities includes persons who have not made past contributions.
